(19) United States
(12) Patent Application Publication
(10) Pub. No.: US 2010/0085183 A1
(43) Pub. Date: Apr. 8, 2010

(54) LOCK MONITORING

(75) Inventor: Daniel Gubler, Brittnau (CH)

Correspondence Address: OBLON, SPIVAK, MCCLELLAND MAIER & NEUSTADT, L.L.P., 1940 DUKE STREET, ALEXANDRIA, VA, 22314, US

(73) Assignee: CWA CONSTRUCTIONS SA, Olten (CH)

(21) Appl. No.: 12/599,103

(22) PCT Filed: May 5, 2008
(86) PCT No.: PCT/CH2008/000205

§ 371 Date: Nov. 6, 2009

(30) Foreign Application Priority Data
May 10, 2007 (CH) 763/07

(51) Int. Cl. G08B 1/08

(52) U.S. Cl. 340/539.1

(57) ABSTRACT

The cars of a passenger transport means are provided with a sensor (3) which scans the state of the locking mechanism and with a transponder antenna (5) which is fitted to the outside of the car (1), and the stations (6) contain transmission antennas (7) which poll signals from the transponder antenna in contactless fashion.

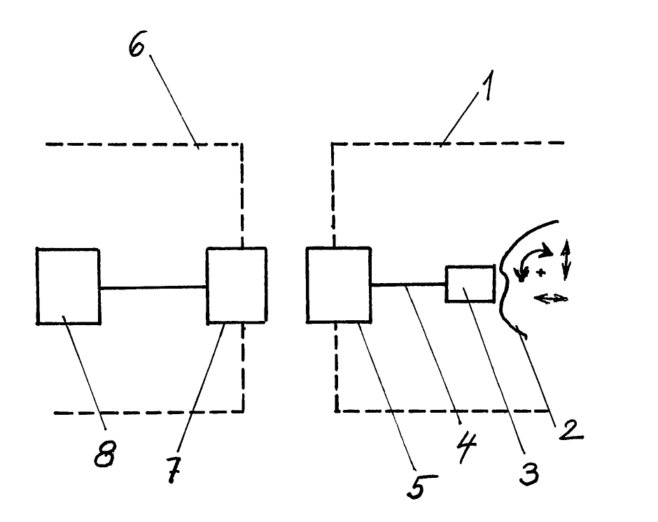

The invention relates to a locking monitoring system for doors on passenger transport means, comprising a device, arranged at a station, for sensing the locking state of the doors, and comprising a device, mounted on the cabin, for transmitting the locking state to the sensing device.

Cabin doors of passenger transport means, particularly those in which there are no operating personnel travelling with passengers in the individual cabins, such as, for example, cableways, must be secured against unintentional or improper opening. This is effected in that, after the doors have been closed, the door is locked in the departure station, and is opened again in the arrival station. This locking must be monitored, in order that the departure of a cabin in which the door has only been closed, but has not been locked, can be prevented.

At present, the monitoring of the locking of cableway cabins is effected by means of a mechanical device. The locking position is transferred mechanically onto a scan bar, which projects at an appropriate location on the cabin, where it is scanned in the stations.

The locking segment in the door automatic device is very small, and must be transformed accordingly for the scan bar. This requires a relatively complicated mechanism, which, on the one hand, is expensive and, on the other hand, is susceptible to faults. This is a problem particularly in the case of cableway cabins, which are exposed to extreme weather conditions.

The invention is therefore based on the object of rendering possible a door-locking monitoring system that does not have the disadvantages of the existing solutions.

This is achieved, according to the invention, in that the device for transmitting the locking state comprises a sensor, which scans the state of the locking mechanism and which is connected to a transponder antenna mounted on the outside of the cabin, and in that sending antennas, which contactlessly poll signals from the transponder antenna, are arranged in the stations.

It is also a substantial advantage of the locking monitoring system according to the invention that no voltage source is required on the cabin side for the signal polling.

A preferred exemplary embodiment of the invention is described in the following with reference to the appended drawing. The drawing shows a block diagram of an arrangement for monitoring the door locking of a cableway cabin.

As shown schematically in the drawing, a sensor 3 is arranged on a reference surface 2, for example a cam disc by which the door closure and the locking are determined, in a cableway cabin 1, which sensor polls the position of the reference surface. The sensor 3 may be an end-position switch, an initiator or the like. The sensor is connected, via a line 4, to a transponder antenna 5 mounted on the outside of the cabin, for example on the roof frame. The transponder antenna is preferably arranged on the cabin on the mast side.

Arranged in the stations 6 are sending antennas 7, which are passed, at a distance, by the transponder antennas 5 of the cabins 1 during departure from the station. The switching state of the sensor, and consequently the state of locking, is polled by the sending antennas by means of a polling signal transmitted inductively to the transponder antennas. A signal is emitted from the sender antenna to an evaluation device 8, which prevents the departure of a cabin if locking thereof has not been effected properly.

1. Locking monitoring system for doors on passenger transport means, comprising a device, arranged at a station, for sensing the locking state of the doors, and comprising a device, mounted on the transport means (1), for transmitting the locking state to the sensing device, characterized in that the device for transmitting the locking state comprises a sensor (3), which scans the state of the locking mechanism and which is connected to a transponder antenna (5) mounted on the outside of the cabin, which transponder antenna does not require any voltage source, and in that sending antennas (7), which contactlessly poll signals from the transponder antenna, are arranged in the stations (6).
